(19) United States
(12) Patent Application Publication
(10) Pub. No.: US 2006/0285942 A1
(43) Pub. Date: Dec. 21, 2006

(54) Bin sweep with brush

(76) Inventors: Craig J. Fridgen, Dumont, MN (US); Andrew R. Young, Dumont, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/366,201

(22) Filed: Mar. 2, 2006

Related U.S. Application Data
(60) Provisional application No. 60/658,305, filed on Mar. 3, 2005.

(51) Int. Cl. B65G 57/00

(52) U.S. Cl. 414/133

(57) ABSTRACT

A bin sweep for removal of particulate from a bin having a floor, wherein the bin sweep includes an auger operated by a power mechanism and the auger comprises one or more auger blades. The bin sweep further includes a brush disposed on a shaft that is attached to the cover of the bin sweep, wherein the brush includes bristles at least in partial contact with the bin floor during operation while the blades of the auger are not in contact with the floor.

### RELATED APPLICATION

The present application claims the benefit of U.S. Provisional Application No. 60/658,305 entitled “Bin Sweep with Flighted Brush,” filed Mar. 3, 2005, which is incorporated herein in its entirety by reference.

### FIELD OF THE INVENTION

This present invention relates generally to bin sweeps used in grain and seed storage facilities. More particularly, the present invention relates to an auger-style bin sweep having a flighted brush to aid in removing grain or seed from storage facilities.

### BACKGROUND OF THE INVENTION

Grain and seed storage facilities, and especially substantially flat-bottomed bins, often include a bin sweep that is used to remove grain or seed from the bin. The bin sweeps often include a flighted auger that is often pivotally and operably mounted to the floor at the center of the bin. To remove grain or seed from the bins, the bin sweep auger is driven clockwise or counter clockwise by a motor so that it sweeps residual grain or seed towards an outlet that is located at the center of the bin.

Bin sweeps are generally used when the bin is nearly empty and the grain or seed in the bin no longer flows via gravitational forces towards the outlet. Instead of manually shoveling the grain or seed out of the bin, the bin sweeps can be used to remove much of the grain or seed from the bins. The bin sweeps are often powered by a small internal combustion engine or electric motor and are self-propelled by a drive wheel or paddle attached to the outer free end of the auger shaft.

Because the augers are often metal, they must often be elevated above the surface of the bin floor to prevent damage to the bin floor or auger. Therefore, even though the bin sweep is usually able to remove much of the grain or seed remaining in the bin, there is often a layer of residual grain or seed that remains in the bin after the bin sweep has passed through the bin that must be manually shoveled out of the bin.

There is therefore a need for an improved bin sweep overcoming the inherent deficiencies of conventional bin sweeps.

### SUMMARY OF THE INVENTION

The bin sweep of the various embodiments of the present invention solves the inherent deficiencies of conventional bin sweeps by providing a system that will remove all or substantially all of the grain, seed, and dust from the bin floor without the need for manual removal.

A feature and advantage of the bin sweep according to the various embodiments of the present invention is that the bin sweep includes a brush in addition to and auger-style bin sweep.

A feature and advantage of the bin sweep according to the various embodiments of the present invention is that the brush can be flighted, such that as the bin sweep and auger move about a central axis of the bin, the brush feeds the grain or seed remaining on the bin floor towards an outlet located near the center of the bin. This can negate or minimize any need for manual removal of grain or seed that is often required with a standard auger-style bin sweep.

A feature and advantage of the bin sweep according to the various embodiments of the present invention is that there is likely a positive impact on insurance premiums, as not requiring any manual removal of grain or seed from the bin negates any injuries that might occur during manual removal. In addition, the risks of inhaling dust and mold into the lungs and the threat of back injuries from manual shoveling and sweeping are eliminated.

### BRIEF DESCRIPTION OF THE DRAWINGS

FIG. 1 is a cutout schematic view of a bin having a bin sweep comprising a flighted brush of the present invention;

FIG. 2 is a side perspective view of a bin sweep having a flighted brush according to a first embodiment of the present invention;

FIG. 3 is a side view of a bin sweep of FIG. 2;

FIG. 4 is a side view of a bin sweep having a flighted brush according to a second embodiment of the present invention; and

FIG. 5 is a side perspective view of a bin sweep having a flighted brush according to an embodiment of the present invention depicting the spring-loaded portion of the flighted brush.

### DETAILED DESCRIPTION OF THE DRAWINGS

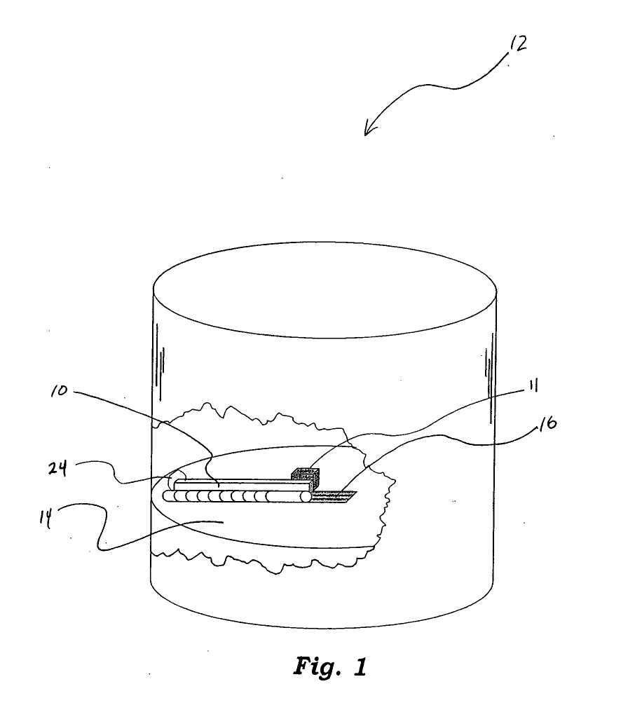

As depicted in FIG. 1, a bin sweep 10 of the present invention is generally used in a circular bin 12 having a substantially flat bin floor 14. The bin sweep 10 can be pivotally mounted near the center of the bin 12 so that it can sweep grain or seed toward an outlet 16 that is located proximate the center of the bin 12.

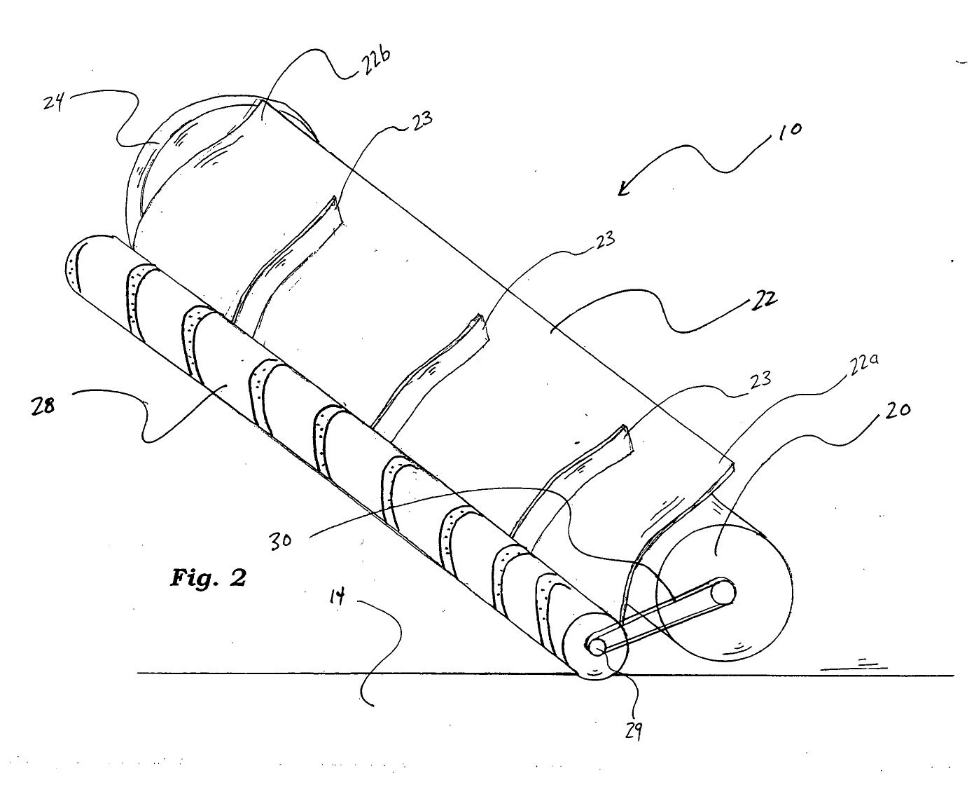

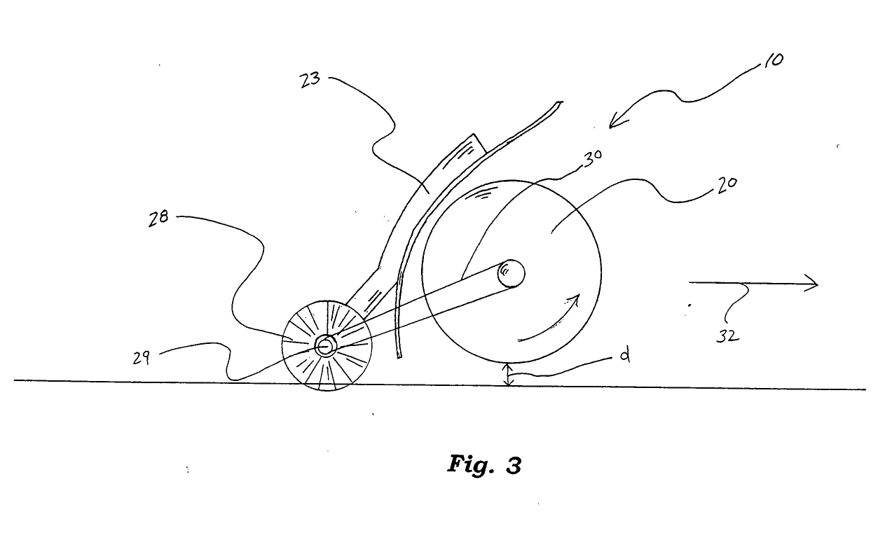

As depicted in FIGS. 2 and 3, a bin sweep 10 according to an embodiment of the present invention generally includes an engine or motor 11 (depicted schematically in FIG. 1), an auger 20, and a cover or housing 22 that at least partially encloses the auger 20, the housing having an first end 22a and a second end 22b generally opposed the first end 22a. The cover 22 can be constructed of a lightweight material, such as tin, but can also be constructed of other materials, such as sheet steel, without departing from the scope of the present invention. The bin sweep 10 also can include either a wheel 24 or skid disposed on the second end so that the bin sweep 10 can move about the bin floor 14 as the motor drives the auger 20 in a clockwise or counter-clockwise direction about the center of the bin 12. In an embodiment, the wheels 24 are weighted to provide the wheels 24 with additional traction as the bin sweep 10 moves within the bin 12.

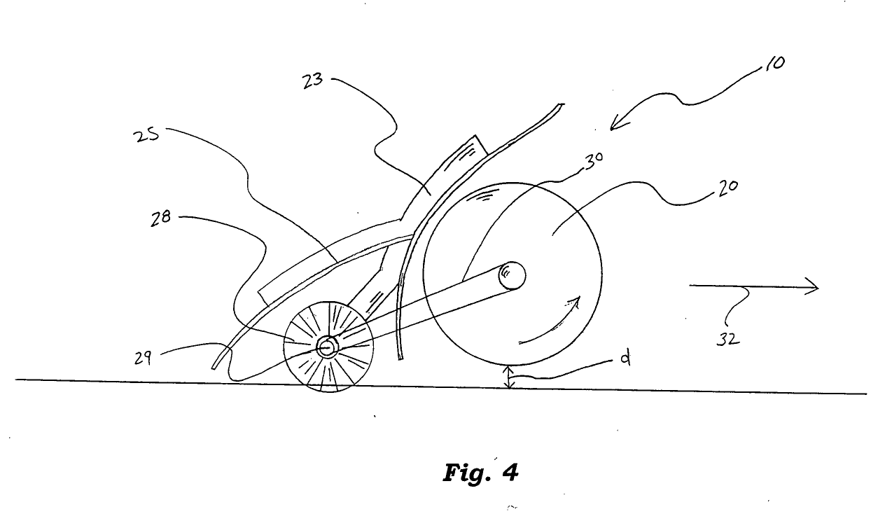

A bin sweep 10 according the present invention comprises a brush 28 disposed on a shaft 29 that is operably attached to the cover or housing 22 of the bin sweep 10. While depicted as being operably attached on an outside of the housing 22, those skilled in the art will recognize that the brush 28 can be disposed on a shaft 29 that is operably attached to an inner portion of the cover 22 of the bin sweep. In addition, as depicted in FIG. 4, when attached on an outside of the housing 22, the brush 28 can be at least partially enclosed by a secondary cover or housing 25.

Although it can be rigid, the shaft 29 can also be flexible or be comprised of several sections to accommodate an uneven bin floor 14. The shaft 29 can be connected to the housing 22 by a plurality of stiffeners or bars 23 that are also connected to the housing 22, the stiffeners 23 also providing rigidity to the housing 22. The stiffeners 23 can include hanger bearings or bushings (not depicted in the figures) to provide smooth and even brush movement while the bin sweep 10 is in operation. The stiffeners 23 can be adjustable to provide the brush 28 the desired contact with the bin floor 14. The stiffeners 23 can be constructed of ⅛″ sheet steel, they can be constructed of other materials, such as tin or aluminum, without departing from the scope of the present invention. In addition, while the stiffeners 23 as depicted in FIGS. 2-5 are relatively wide, they can also be relatively flat or narrow without departing from the scope of the present invention.

The brush 28 can be flighted in a spiral fashion, although in another embodiment of the present invention the brush 28 is not flighted. In the various embodiments wherein the brush 28 is flighted, the flighting can vary in degrees with respect to the brush shaft 29 (e.g., angles between 15° and 90° including, but not limited to, 15°, 30°, 45°, 60°, and 75°). In addition, in the various embodiments of the present invention, the brush 28 can be of varying diameters and lengths. While the brush 28 can span the entire length of the housing 22, in another embodiment of the present invention the brush 28 only partially spans the length of the housing 28.

The brush 28 can be comprised of a plurality of bristles. The bristles may be long, short, stiff, soft, wide, narrow, and any combination thereof. Soft bristles can be used when the bin sweep 10 is used in conjunction with a seed storage bin, as the soft bristles are gentle on the seeds and thus prevent damaging the seeds. When in operation, the bristles 28 are can be substantially in contact with the bin floor 14. This is accomplished through gravity, spring pressure from a spring portion forcing the brush to the floor, other biasing means, or a combination thereof. In one embodiment of the present invention, the brush 28 and/or shaft are flexible to allow for unevenness in the bin floor 14.

The brush 28 can be connected to the auger 20 with and driven by a chain or belt drive 30, although the brush 28 can be static or alternatively can include a separate gas, electric, or hydraulic motor or engine to drive the brush 28. The brush 28 can be driven by the chain or belt drive 30. Alternatively, the brush 28 can be driven by a direct drive or gear box drive. The bin sweep 10 may include single or multiple pulleys and/or sprockets to vary the speed of the bin sweep 10 during operation. Also, different sized pulleys and/or sprockets may be used to vary the speed of the brush 28.

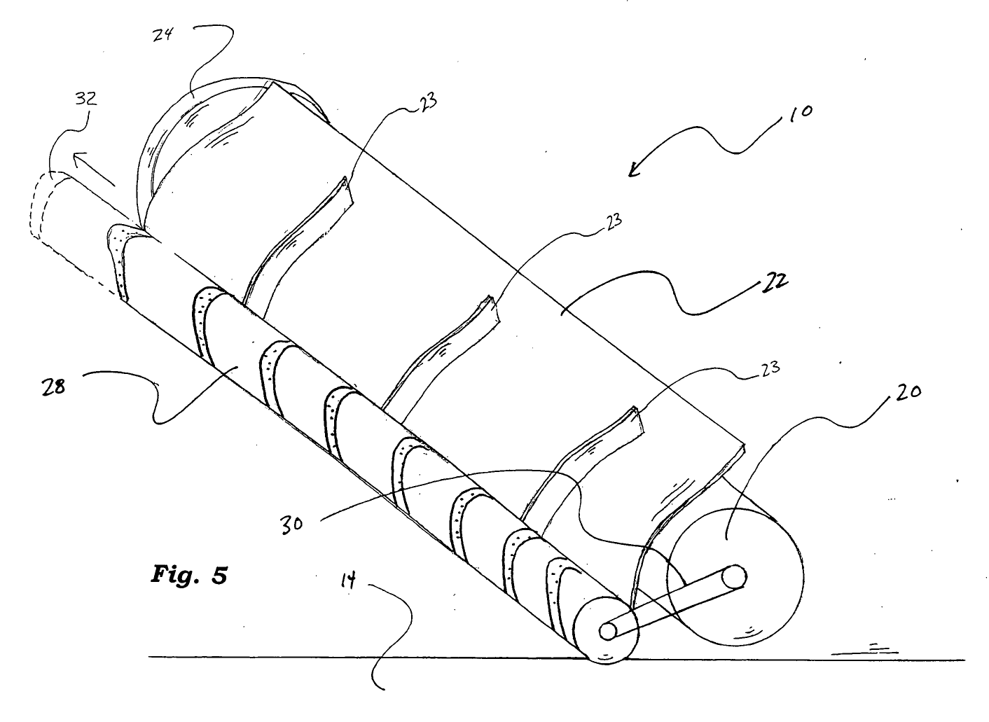

As depicted in FIG. 5, in one embodiment of the present invention, the brush 28 includes a spring-loaded portion 32 proximate the bin end. The dashed portion represents the spring-loaded portion 32 of the brush 28 after the spring has biased the brush 28 towards the bin wall. The spring-loaded portion 32 assists the bin sweep 10 in capturing all grain or seed out to the edge of the bin 12 near the bin wall. The second end 22b can include includes a replaceable bumper or glide constructed of a substantially soft material, such as polypropylene, so that the second end does not damage the bin wall when the bin sweep 10 is in operation and also to allow for easy movement or sliding of the bin sweep 10 along the bin wall.

Because the bin floor 14 is not likely completely flat or even, the auger 20 can be disposed at a height “d” above the bin floor 14 to prevent damage to the bin floor 14 and auger 20 that would occur by contact between the bin floor 14 and auger 20. The cover 22 can also be disposed at a height above the bin floor 14 to inhibit damage to the cover 22 and/or bin floor 14.

In operation, the bin sweep 10 according to the various embodiments of the present invention moves along the bin floor 14 in a sweep direction 32. As the bin sweep 10 passes over the bin floor 14, the motor-driven auger 20 moves a substantial amount of the grain or seed towards the outlet 16. The flighted brush 28 then follows after the auger 20 and sweeps any remaining grain or seed towards the outlet 16. After the auger 20 and brush 28 have passed over the bin floor 14, there is little, if any, grain, seed, fines, or dust remaining on the bin floor 14, thus negating any need for manual removal of grain or seed from the bin floor 14. The sweeping action of the bin sweep 10 and brush 28 is also gentle on the grain or seed.

Referring to FIGS. 3 and 4, as with standard bin sweeps, because the auger 20 and cover 22 are disposed at a height “d” above the bin floor 14, there often can remain a layer or residual amount of grain or seed left on the bin floor 14 immediately after the bin sweep 10 has passed over the grain or seed. However, in the various embodiments of the present invention, the brush 28, unlike the auger, can be in actual contact the bin floor 14. As a result, the brush 28 will remove substantially all of the remaining grain or seed from the bin floor. Moreover, because the brush 28 can be flighted, it can feed the residual amounts of grain or seed towards the center of the bin where the outlet 16 is located.

In one embodiment of the present invention, the outlet 16 is located proximate the bin wall and not the center of the bin 12. In this embodiment, the flighted brush 28 would be oriented such that it would move the grain or seed from the center and middle of the bin 12 outwardly and dispense the grain or seed in an outlet located proximate the bin wall.

In another embodiment of the present invention, the brush 28 is located on a leading edge of the cover or housing 22 of the bin sweep 10.

In another embodiment of the present invention, the auger 20 can be a flighted brush instead of a steel auger. In this embodiment, the bin sweep 10 the brush 28 can be either included or not included.

The bin sweep 10 according to the various embodiments of the present invention can also be used on a grain or seed storage system having an angled or not flat bottom.

The bin sweep 10 according to the various embodiments of the present invention can be easily installed or transferred from one bin to another bin. The flighted brush 28 can be adaptable to fit any type of bin sweep and can be added to retrofit an existing bin sweep.

As stated above, referring to FIG. 4, the bin sweep 10 according to the various embodiments of the present invention can include a secondary shroud to cover the brush.

The bin sweep 10 of the present invention can be used in small bins 12 or large bins. For example, the bin sweep 10 of the present invention can be used in small bins 12 having a 17′ diameter or large bins 12 having a 100′ diameter.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A bin sweep for removal of particulate from a bin having a floor, the bin sweep comprising:
an auger operated by a power mechanism, wherein the auger comprises one or more auger blades; and
a brush disposed on a shaft, wherein at least a portion of the brush is in contact with the bin floor during operation of the bin sweep while the one or more auger blades are positioned at a spaced-apart distance from the bin floor.

2. The bin sweep of claim 1, wherein the auger is at least partially enclosed in a housing and the brush is operably attached to the housing.

3. The bin sweep of claim 2, wherein the brush is operably attached to an exterior of the housing.

4. The bin sweep of claim 1, wherein the brush is flighted.

5. The bin sweep of claim 1, wherein the brush is operated by the power mechanism.

6. The bin sweep of claim 5, wherein the brush is operably connected to the auger with at least one of a chain or belt drive.

7. The bin sweep of claim 1, wherein the brush comprises an inner end and an outer end, the outer end comprising an outwardly biased and extending spring-loaded brush portion.

8. The bin sweep of claim 1, wherein the shaft comprises a flexible portion to allow for any unevenness in the bin floor.

9. The bin sweep of claim 1, wherein the auger comprises a second brush.

10. A method of using a bin sweep for removal of grain from a bin having a floor, the method comprising:
providing an auger having one or more blades and enclosed a housing, wherein the one or more blades are positioned at a spaced-apart distance from the bin floor;
further providing a brush operably coupled to the housing; and
operating the auger about the bin such that the auger effects movement of grain towards an opening on the bin floor, wherein at least a portion of the brush is in contact with the bin floor during operation of the auger to effect movement of grain positioned between the one or more blades and floor.

11. The bin sweep of claim 10, wherein flighting is provided on the brush, such that movement of the grain positioned between the one or more blades and floor is effected towards the opening.

12. The bin sweep of claim 10, wherein the brush is operated by a power mechanism selected from the group consisting of: a gas engine, an electric engine, and a hydraulic motor.

13. The bin sweep of claim 10, wherein the brush is placed into contact with the bin floor with spring pressure.

14. A method of installing a bin sweep for removal of grain from a bin having a floor, the method comprising:
providing a pre-installed auger having one or more blades and at least partially enclosed in a housing, wherein the one or more blades are positioned at a spaced-apart distance from the bin floor; and
operably coupling a brush to the housing, wherein the brush is presented on a shaft and positioned such that at least a portion of the brush is in contact with the bin floor.

15. The method of claim 14, wherein flighting is provided on the brush.

16. The method of claim 14, wherein the brush is operably coupled to an exterior of the housing.

17. The method of claim 16, further comprising at least partially enclosing the brush with a second housing on the exterior of the housing.
